(19) United States
(12) Patent Application Publication
(10) Pub. No.: US 2025/0251092 A1
(43) Pub. Date: Aug. 7, 2025

(54) PORTABLE IOT-ENABLED GAS STORAGE SYSTEM WITH INTEGRATED HIDDEN MODULE

(71) Applicant: Atomis Inc., Kobe-shi (JP)

(72) Inventors: Daisuke ASARI, Kobe-shi (JP); Masakazu HIGUCHI, Kobe-shi (JP); Shinji KATO, Kobe-shi (JP); Yukiko NOGUCHI, Kobe-shi (JP)

(21) Appl. No.: 19/190,676

(22) Filed: Apr. 27, 2025

Related U.S. Application Data
(63) Continuation-in-part of application No. 16/632,587, filed on Jan. 21, 2020, now abandoned.

(30) Foreign Application Priority Data
Jul. 31, 2017 (JP) 2017147901

(51) Int. Cl. F17C 13/02; F17C 11/00

(52) U.S. Cl. CPC F17C 13/025; F17C 11/00; F17C 13/026; F17C 2201/0128; F17C 2201/0157; F17C 2205/0165; F17C 2205/0169; F17C 2250/034; F17C 2250/043; F17C 2250/0439

(57) ABSTRACT

Provided is an Internet of Things (IoT) enabled gas storage container that is easy to transport and install. The portable gas storage container according to the present invention has flat upper and lower surfaces and can be stacked vertically. The gas storage container according to the present invention may include a casing that has a flat upper surface and a flat lower surface and is vertically stackable, and a gas container installed in the casing. Communication with a remote device such as a mobile phone or computer regarding a gas remaining amount can be made through a wireless IoT communication for determining the need to replace or refill the gas storage container.

### CROSS-REFERENCE TO RELATED APPLICATIONS

This application is a continuation-in-part of U.S. patent application Ser. No. 16/632,587, filed on Jan. 21, 2020 which is a 371 National Phase Entry of International Patent Application PCT/JP2018/028550 filed on Jul. 31, 2018, which claims priority to Japan Patent Application No. 2017-147901 filed Jul. 31, 2017, the disclosures of which are incorporated by reference herein.

### FIELD OF THE INVENTION

The present invention relates to a gas storage container having a specific shape and, optionally, Internet of Things (IoT) communication with a remote device for determining when to replace or refill the gas storage container.

### BACKGROUND OF THE INVENTION

Gas cylinders having a large weight and a bottle shape have been generally used. However, such gas cylinders are not easy to handle as they have large occupied volume and are difficult to transport and install. Also, such gas cylinders are not meant to have aesthetic appearances. Further, it may be difficult to remotely determine when there is a need to replace or refill the gas storage container as there is no communication with remote computing devices.

### CITATION LIST

### Patent Literature

[Patent Literature 1] Japanese Unexamined Patent Application Publication No. 2015-178906

### SUMMARY OF THE INVENTION

### Technical Problem

An object of the present invention is to provide a portable gas storage container that are easy to transport and install.

### Solution to Problem

Some aspects of the present invention are as described below.
[1] A gas storage container comprising a flat upper surface and a flat lower surface, and being vertically stackable.
[2] The gas storage container according to [1], having a prismatic shape.
[3] The gas storage container according to [2], having a quadrangular prism shape, a pentagonal prism shape, or a hexagonal prism shape.
[4] The gas storage container according to [3], having a rectangular parallelepiped shape or a cubic shape.
[5] The gas storage container according to any one of [1] to [4], wherein a gas outlet is provided on at least one side surface thereof.
[6] The gas storage container according to [5], wherein the at least one side surface has a recess, and the gas inlet is provided in the recess.
[7] The gas storage container according to any one of [1] to [6], further comprising a grip.
[8] The gas storage container according to any one of [1] to [7], wherein an inner surface thereof is spherical, cylindrical, or elliptical.
[9] A gas storage container according to any one of [1] to [8], comprising: a casing with a flat upper surface and a flat lower surface and are vertically stackable; and a gas container installed in the casing.
[10] The gas storage container according to any one of [1] to [9], further comprising a gas remaining amount measurement module.
[11] The gas storage container according to [9], further comprising a gas remaining amount measurement module in a space between the casing and the gas container.
[12] The gas storage container according to [10] or [11], wherein the gas remaining amount measurement module comprises a temperature sensor.
[13] The gas storage container according to any one of [10] to [12], wherein the gas remaining amount measurement module is configured to be capable of wireless communication.
[14] The gas storage container according to any one of [10] to [13], wherein the gas remaining amount measurement module is configured to perform global positioning system (GPS) communication.
[15] The gas storage container according to any one of [1] to [14], further comprising a porous material therein.
[16] The gas storage container according to [15], wherein the porous material is a metal organic framework.

### Advantageous Effects of Invention

According to the present invention, it becomes possible to provide a gas storage container that is easy to transport and install.

### BRIEF DESCRIPTION OF THE DRAWINGS

FIG. 1 is a perspective view showing a gas storage container according to an embodiment of the present invention.

FIG. 2 is a cross-sectional view of the gas storage container shown in FIG. 1.

FIG. 3 is a perspective view illustrating a state in which a plurality of the gas storage containers according to an embodiment of the present invention are vertically stacked.

FIG. 4 is a conceptual diagram illustrating an example of a configuration of a gas remaining amount measurement module.

FIG. 5 is a perspective view showing a gas storage container according to another embodiment of the present invention.

FIG. 6 is a perspective view showing a gas storage container according to another embodiment of the present invention.

FIG. 7 is a perspective view showing a gas storage container according to another embodiment of the present invention.

FIG. 8 is a perspective view showing a gas storage container according to another embodiment of the present invention.

FIG. 9 is a perspective view showing a gas storage container according to another embodiment of the present invention.

FIG. 10 is a perspective view showing a gas storage container according to another embodiment of the present invention.

FIG. 11 is a perspective view showing a gas storage container according to another embodiment of the present invention.

FIG. 12 is a perspective view showing a gas storage container according to another embodiment of the present invention.

FIG. 13 is a cross-sectional view of the gas storage container shown in FIG. 12.

FIG. 14 is a perspective view showing a gas storage container according to another embodiment of the present invention.

FIG. 15 is a cross-sectional view of the gas storage container shown in FIG. 14.

FIG. 16 is a perspective view showing a gas storage container according to another embodiment of the present invention.

FIG. 17 is a graph showing an example of a gas storage amount.

FIG. 18 is a graph showing an example of a gas storage amount.

FIG. 19 is a graph showing an example of a gas storage amount.

FIG. 20 is a graph showing an example of a gas storage amount.

### DETAILED DESCRIPTION

The gas storage container according to the present invention has flat upper and lower surfaces and can be stacked vertically. Adopting such a configuration makes it possible to easily and effectively transport and install the gas storage container. Examples of such gas storage containers will be described below.

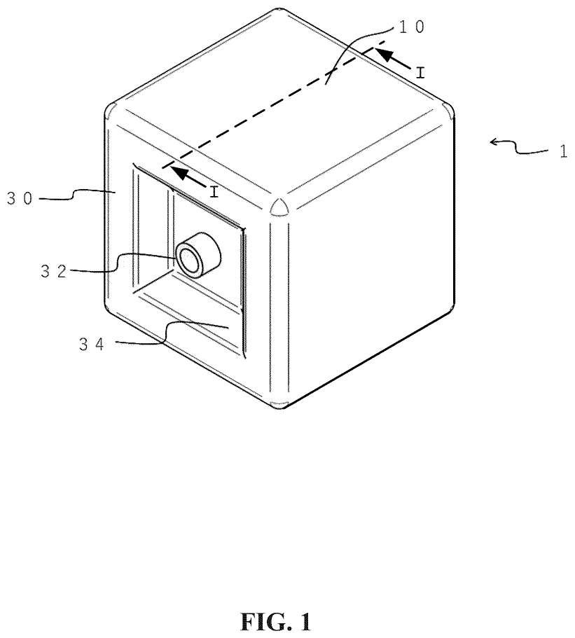

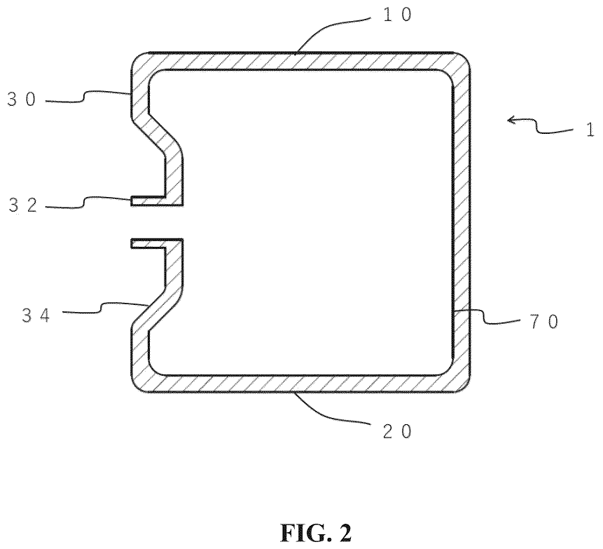

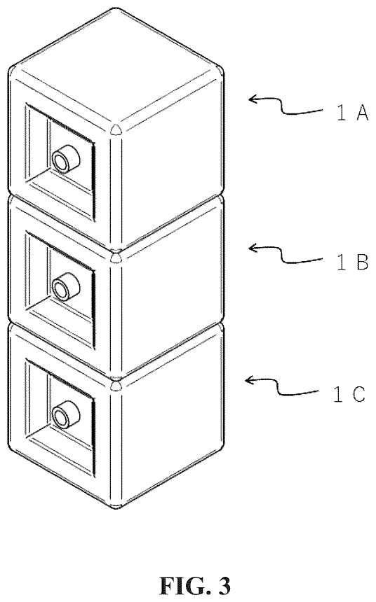

FIG. 1 is a perspective view showing a portable gas storage container according to an embodiment of the present invention. FIG. 2 is a cross-sectional view of the gas storage container shown in FIG. 1 along line I. FIG. 3 is a perspective view illustrating a state in which a plurality of the gas storage containers according to an embodiment of the present invention are stacked one above the other.

The portable gas storage container 1 shown in FIGS. 1 and 2 has a cubic shape, and includes an upper surface 10, a lower surface 20, and four side surfaces 30. Both the upper surface 10 and the lower surface 20 are flat and typically have the same shape. This makes it possible to vertically stack the gas storage containers 1 one above the other. FIG. 3 shows an example in which three gas storage containers 1A to 1C are vertically stacked.

The side surface 30 of the gas storage container 1 is typically provided with a gas outlet 32. The side surface 30 is provided with a recess 34, and the gas outlet 32 is provided in the recess 34. Adopting such a configuration makes it possible to reduce the occupied volume of the gas storage container 1, thereby facilitating its transportation and the like. The gas outlet 32 usually also serves as a gas inlet.

In this embodiment and in all of the embodiments of the gas storage container that include a recess, the gas outlet is entirely contained within the recess of the gas storage container. In this manner, the gas outlet does not protrude beyond the periphery of the gas storage container, ensuring that the gas storage container is stackable on all sides, including a side that includes a gas outlet. Because the gas outlet is recessed, it will not be damaged in the stacking process, particularly during transport and storage. Note that the gas storage containing is sized and configured so that it is easily portable and able to be lifted and stacked by the average adult user. For example, the containers can be ported by the user from the point of gas sale in an automobile, scooter, or bicycle.

Further, delivery personnel can readily stack and transport the containers to home or business users in a small delivery vehicle such as an open-bed truck. To this end, the exterior material of the gas storage container may be made waterproof, such as a rigid plastic (e.g., polyethylene, polystyrene, polycarbonate, polyvinyl chloride), in order to withstand outdoor storage or delivery conditions. Fiber-reinforced polymers may also be used for the gas storage container, such as aramid, carbon and glass fibers in a resin matrix such as epoxy, polyester and vinyl ester-based resins and mixtures thereof.

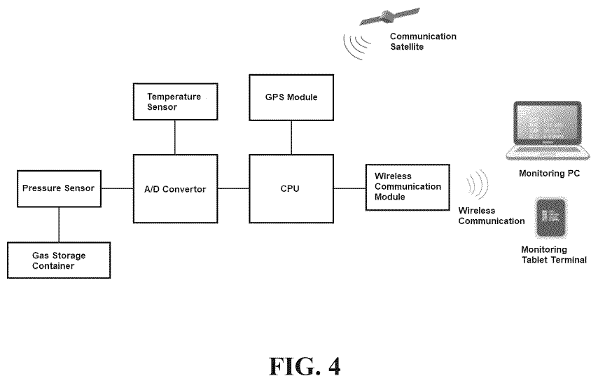

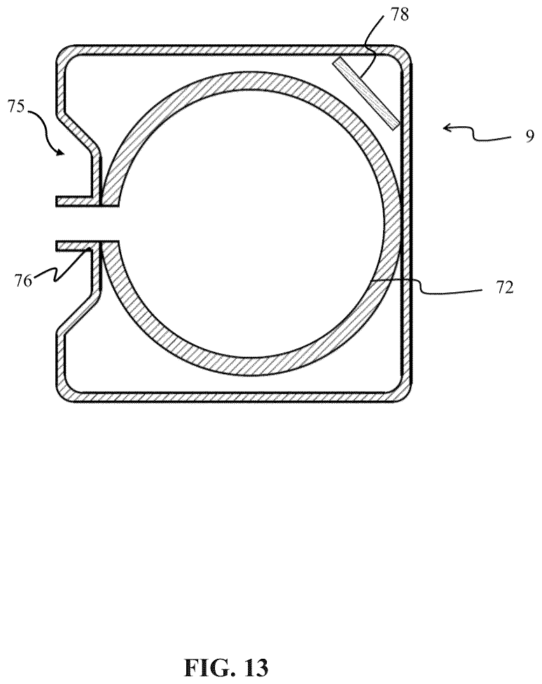

The gas outlet 32 is typically provided with a gas remaining amount measurement module. This module is schematically depicted in FIG. 4. FIG. 13 depicts the gas remaining amount measurement module 78 and its position between the gas container casing and the inner gas containing portion, with cables omitted for clarity. The gas remaining amount measurement module is preferably configured to perform wireless communication. The gas remaining amount measurement module may be configured to perform GPS communication. Adopting such a configuration makes it possible to remotely manage the gas remaining amount in the gas storage container 1.

FIG. 4 is a conceptual diagram illustrating an example of a configuration of a gas remaining amount measurement module. The gas remaining amount measurement module shown in FIG. 4 is an Internet of Things (IoT) module, and includes a pressure sensor, a temperature sensor, an analog/digital (A/D) converter connected to both sensors, and a central processing unit (CPU) connected to the A/D converter. The CPU is further connected to a wireless communication module configured to perform wireless communication and a GPS communication module configured to perform GPS communication. The wireless communication module is used, for example, to transmit measurement value data to a monitor personal computer (PC) or tablet etc. In the example shown in FIG. 4, information on temperature (25° C.), position (135.405 degrees east longitude/35.010 degrees north latitude), and pressure (9.85 MPa) is displayed on the monitor PC or tablet. For instance, a Bluetooth® (communication module can be used as the wireless communication module. Using such a gas remaining amount measurement module makes it possible for the user to easily follow the remaining amount and position information of the gas storage container. This also facilitates inventory management and distribution management of the gas storage containers. In this manner, remote personnel can determine when it is time to replace or refill the gas storage container before the gas supply is exhausted.

The inner surface 70 of the gas storage container 1 has a cubic shape which are substantially the same as the outer shape. Adopting such a configuration makes it possible to maximize the amount of gas stored in the gas storage container 1.

Any material can be used for the gas storage container 1. For example, the gas storage container 1 can be made of a metal or an alloy. Alternatively, the gas storage container 1 may be made of fiber reinforced plastic, or may include both a fiber reinforced plastic and a metal or an alloy. Alternatively, the gas storage container 1 may be made of duralumin. The material used for the gas storage container 1 can be appropriately selected in consideration of formability and weight.

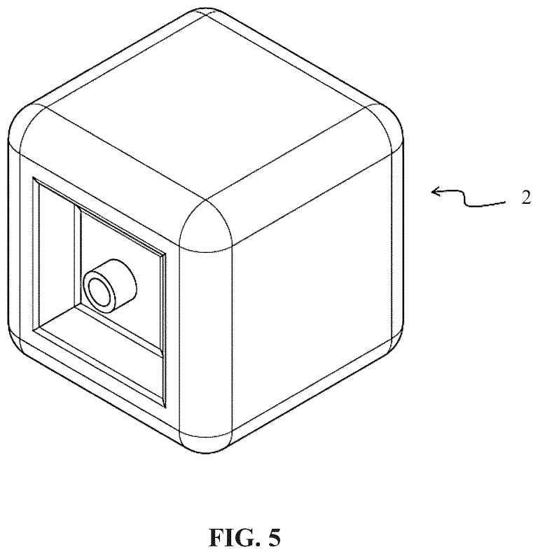

FIG. 5 is a perspective view showing a gas storage container 2 according to another embodiment of the present invention. The gas storage container 2 shown in FIG. 5 has the same configuration as that of the gas storage container 1 shown in FIG. 1 except that it has a larger chamfer. Further, all of the gas storage containers may include rounded edges and corners. Adopting such a configuration makes it possible to improve the pressure resistance of the gas storage container 2 and to give the user a softer exterior impression. It should be noted that the gas storage container 1 does not need to have chamfering as shown in FIG. 1 and FIG. 5.

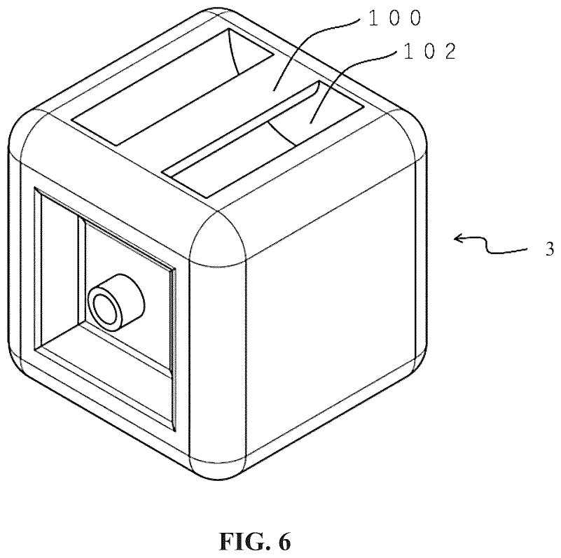

FIG. 6 is a perspective view showing a gas storage container according to another embodiment of the present invention. The gas storage container 3 shown in FIG. 6 has the same configuration as that of the gas storage container 2 shown in FIG. 5 except that it further has a grip 100 on the upper surface. Adopting such a configuration makes it easier for the user to transport the gas storage container 3.

In the gas storage container 3 shown in FIG. 6, a recess 102 is provided on the upper surface 10. This configuration allows the grip 100 not to protrude from the upper surface 10. Adopting such a configuration makes it easier to stack the gas storage container 1 in a vertical direction. The grip 100 may be provided on the upper surface 10 so as to be foldable.

The integrally-formed grip 100 may be provided other than the upper surface of the gas storage container 3. In other words, the grip 100 may be provided anywhere outside the gas storage container 3. For example, the grip 100 may be provided on the outer surface of the gas storage container 3 or may be provided on the outer corner of the gas storage container 3.

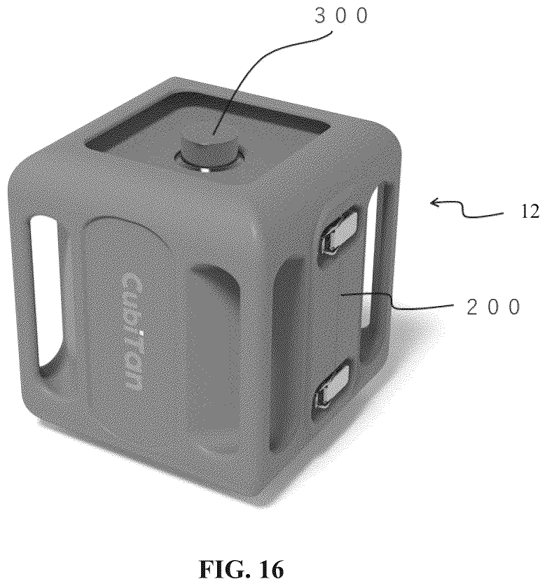

As seen in FIG. 6 and FIG. 16, the integrally-formed grip 100 spans the entire length of a gas storage container side, while including end portions that adequately support the grip within the structure of the gas storage container. This configuration permits the grip to be easily handled by the user without protruding from the case, permitting the gas storage container to be readily moved while still being flat and stackable. That is, the grip forms part of the exterior profile of the gas storage container and is flush with the surface of the gas storage container.

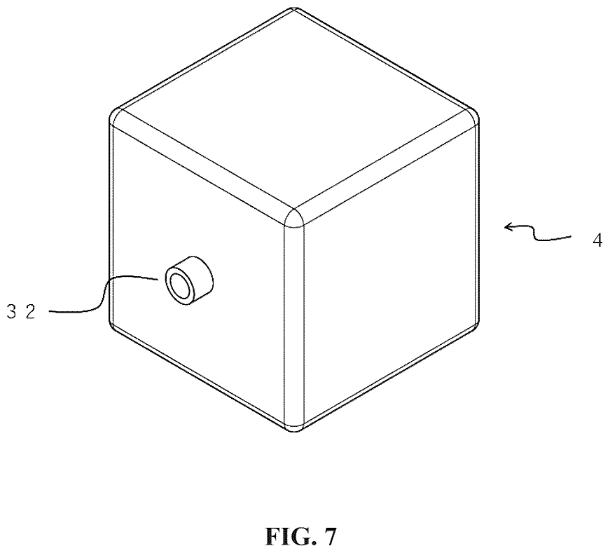

FIG. 7 is a perspective view showing a gas storage container 4 according to another embodiment of the present invention. The gas storage container 4 shown in FIG. 7 has the same configuration as the gas storage container 1 shown in FIG. 1 except that the side surface 30 provided with the gas outlet 32 does not have a recess. Absence of the recess would make it possible to store a generally larger amount of gas compared to the configuration shown in FIG. 1.

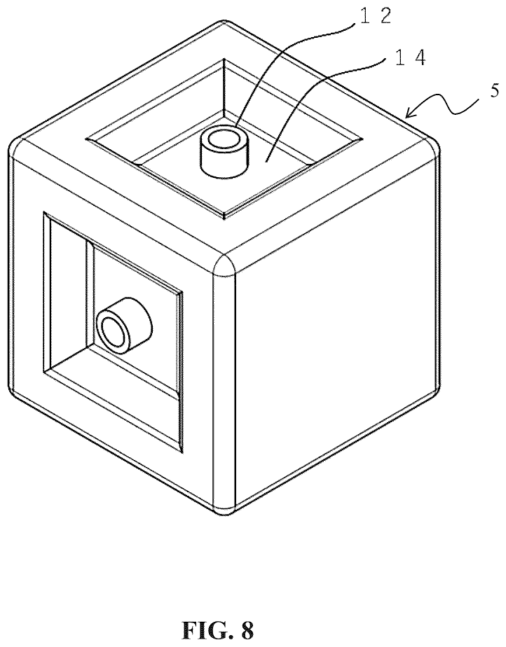

FIG. 8 is a perspective view showing a gas storage container 5 according to another embodiment of the present invention. The gas storage container 5 shown in FIG. 8 has the same configuration as the gas storage container 1 shown in FIG. 1 except that the upper surface 10 is also provided with a gas outlet 12 and a recess 14. Adopting such a configuration makes it possible to discharge or introduce gas from both the upper surface 10 and the side surface 30. Moreover, by connecting the gas outlets of the plurality of gas storage containers 5, for example, the effective capacity of the gas storage container 1 can be increased. As described with reference to FIG. 7, the recess 14 may be omitted.

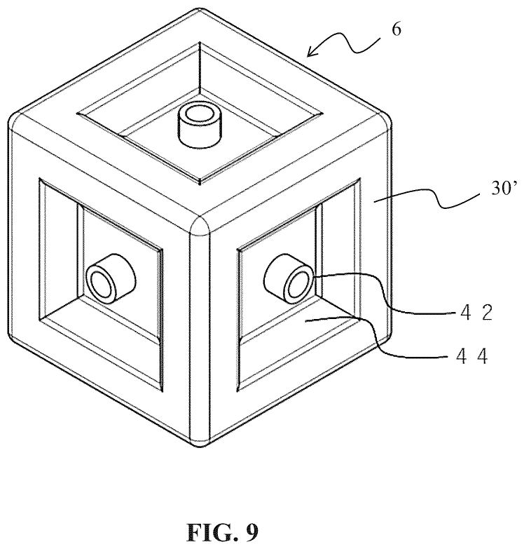

FIG. 9 is a perspective view showing a gas storage container 6 according to another embodiment of the present invention. The gas storage container 6 shown in FIG. 9 has the same configuration as the gas storage container 5 shown in FIG. 8 except that the other side surface 30′ is also provided with a gas outlet 42 and a recess 44. Adopting such a configuration makes it possible to discharge or introduce gas from a plurality of side surfaces. Moreover, by connecting the gas outlets of the plurality of gas storage containers 6, for example, the effective capacity of the gas storage container 1 can be increased. As described with reference to FIG. 7, the recess 44 may be omitted. Moreover, gas inlets (and recesses) can also be provided in a lower surface and other side surfaces.

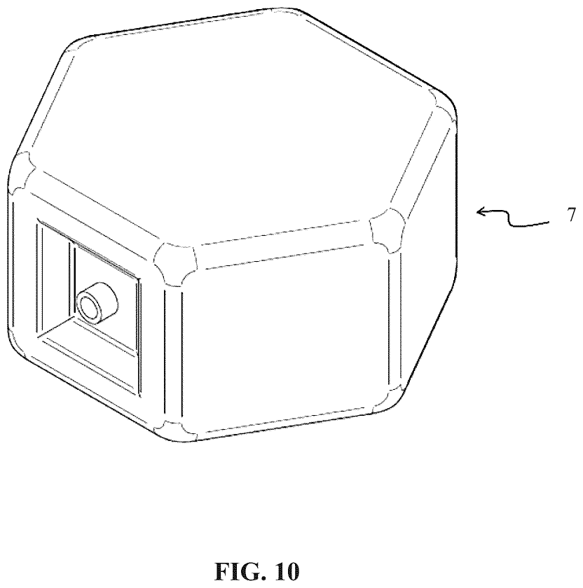

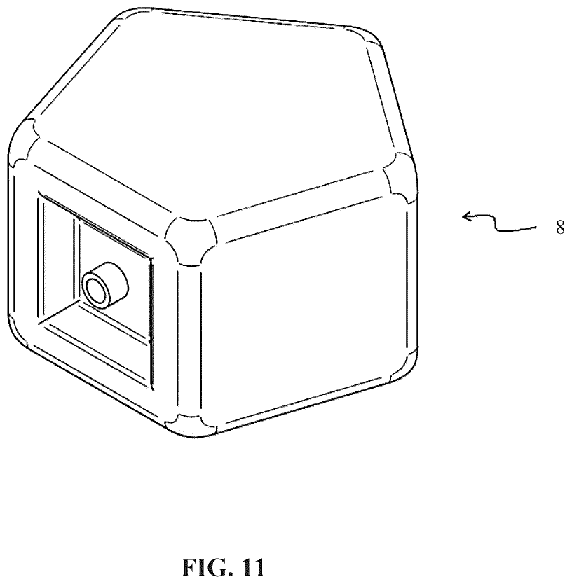

FIGS. 10 and 11 are perspective views showing a gas storage container 7 and 8, respectively, according to another embodiment of the present invention. The gas storage container 7 shown in FIG. 10 has the same configuration as the gas storage container 1 shown in FIG. 1 except that it has a regular hexagonal prism shape. The gas storage container 8 shown in FIG. 11 has the same configuration as the gas storage container 1 shown in FIG. 1 except that it has a regular pentagonal prism shape. Adopting such shapes also makes it easier to transport and install the gas storage container 8.

The shape of the gas storage container 1 is not particularly limited as long as the upper and lower surfaces are flat and can be stacked vertically. The gas storage container 1 has, for example, a cylindrical shape or a prismatic shape, and preferably has a quadrangular prism shape, a pentagonal prism shape, or a hexagonal prism shape. When the gas storage container 1 has a prismatic shape, the gas storage container 1 preferably has a regular polygonal column shape. The gas storage container 1 is more preferably a rectangular parallelepiped or a cube, and particularly preferably a cube.

The shape of the inner surface of the gas storage container 1 is, for example, substantially the same as the shape of the outer surface, as shown in FIG. 2. The shape of the inner surface of the gas storage container 1 may be different from the shape of the outer surface. For example, the inner surface of the gas storage container 1 may be spherical, cylindrical, or elliptical. Adopting such a configuration makes it possible to improve the pressure resistance of the gas storage container 1.

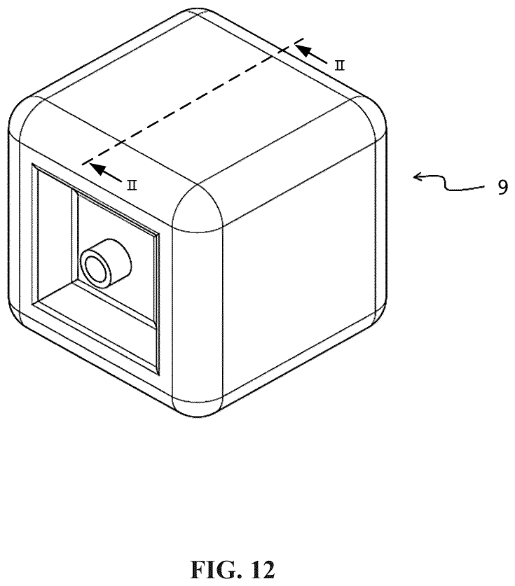

FIG. 12 is a perspective view showing a gas storage container 9 according to another embodiment of the present invention. FIG. 13 is a cross-sectional view of the gas storage container 9 shown in FIG. 12 along the line II. The gas storage container 9 shown in FIGS. 12 and 13 has the same configuration as the gas storage container 1 shown in FIGS. 1 and 2 except that the inner surface 72 is spherical. Adopting such a configuration makes it possible to improve the pressure resistance of the gas storage container 9. As seen in FIGS. 12 and 13, the gas storage container includes a recess 74 and a gas outlet 76. As seen in FIG. 13, the gas outlet 76 is positioned within the recess 74 such that a gas outlet is entirely positioned within the recess 74 of the casing. Note that the outer casing of the gas storage container has sufficient structural strength to provide shock resistance and crush resistance to the inner container that holds the gas. Therefore, the space between the inner wall 72 and the outer wall can be a void that does not include any filler. In this manner, there is space to house the gas remaining amount measurement module 78 as seen in FIG. 13.

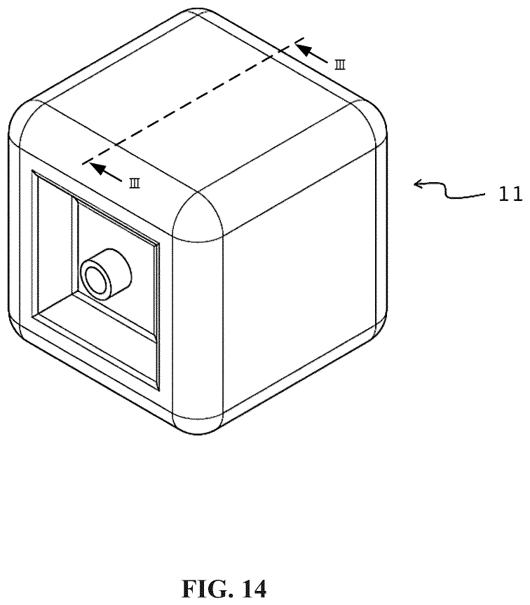

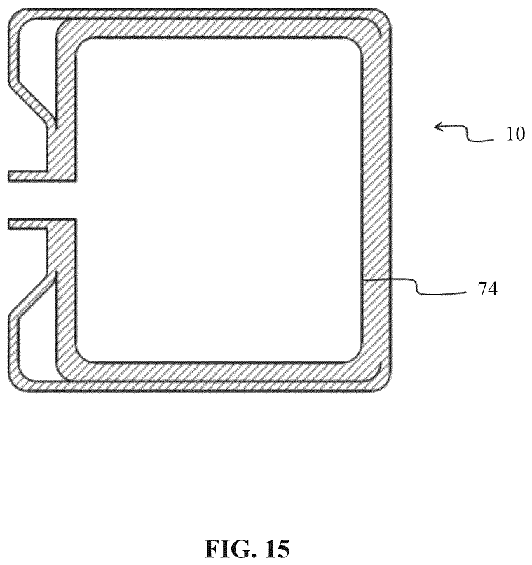

FIG. 14 is a perspective view showing a gas storage container 11 according to another embodiment of the present invention. FIG. 15 is a cross-sectional view of the gas storage container shown in FIG. 14 along the line III. The gas storage container 11 shown in FIGS. 14 and 15 has the same configuration as the gas storage container 1 shown in FIGS. 1 and 2 except that the inner surface 74 is cylindrical. Adopting such a configuration makes it possible to improve the pressure resistance of the gas storage container 11.

The gas storage container according to the present invention may include a casing that has a flat upper surface and a flat lower surface and is vertically stackable, and a gas container installed in the casing. In this case, it is possible to provide a gas storage container that can be easily transported and installed regardless of the shape of the gas container. The material used for the casing and the gas container may be different from each other. Therefore, it is possible to adjust the strength, weight, pressure resistance, appearance, and the like of the entire gas storage container by optimizing the material for the casing and the material of the gas container. As the material for the gas container, for example, those exemplified above as the material of the gas storage container can be used. On the other hand, as the material for the casing, plastics, metals, alloys, and the like can be used as appropriate in addition to those exemplified as the material for the gas storage container.

FIG. 16 is a perspective view showing a gas storage container 12 according to another embodiment of the present invention. The gas storage container 12 shown in FIG. 16 includes a casing 200 and a gas container 300 installed therein. The casing 200 has a substantially cubic shape and is made of plastic. A grip is provided at an outer corner portion of the casing 200. The gas container 300 is made of fiber reinforced plastic and is installed in the casing 200. The gas outlet of the gas container 300 is exposed to the outside through the casing 200. Adopting such a configuration makes it possible to provide a gas storage container that is easy to transport and install while enhancing pressure resistance.

When a gas storage container is provided with the casing and the gas container, the gas residual amount measurement module mentioned above can be installed in a space between the casing and the gas container, similarly as shown in FIG. 13, so as not to be visible from outside. This makes it difficult to visually recognize the gas residual amount measurement module from the outside, making it less likely to impair the appearance aesthetics. Note that the gas storage container possesses sufficient structural strength as the casing provides shock resistance and crush-resistance to the gas container. Therefore, the space between the casing and the gas container can be a void that does not include any filler. In this manner, there is space to house the gas remaining amount measurement module between the casing and the gas container.

The gas storage container according to the present invention may further contain a porous material therein. The porous material may be filled so that the gas storage container satisfies the following condition at 298 K for at least one kind of gas. That is, the difference (Δ_{1M}=G_{1M}−G_{0.1M}) between the gas content at 1 MPa (G_{1M}) and the gas content at 0.1 MPa (G_{0.1M}) when the porous material is contained is at least twice the difference (δ_{1M}=g_{1M}−g_{0.1M}) between the gas content at 1 MPa (g_{1M}) and the gas content at 0.1 MPa (g_{0.1M}) when the porous material is not contained. In other words, the gas storage container according to the present invention may preferably satisfy Δ_{1M}/δ_{1M}≥1.5 at 298 K for at least one kind of gas, and more preferably satisfy Δ_{1M}/δ_{1M}≥2 at 298 K for at least one kind of gas

The gas content at 0.1 MPa (G_{0.1M}) is a gas content at almost atmospheric pressure. That is, this value can be a guideline for a limit value at which the gas storage container can release the gas without decompression.

Conventional gas cylinders are usually filled with gas up to a high pressure of 14.7 MPa. This is because the pressure and the gas storage amount are directly proportional to each other in the case of a conventional gas cylinder, so that a sufficient amount of gas cannot be stored unless the pressure is increased. On the other hand, when a gas storage container that satisfies the above conditions is used, a high gas storage amount can be achieved at a relatively low pressure.

The gas storage amount Gₜₒₜₐₗ of the gas storage container according to this embodiment can be calculated by the following equation.

$${G}_{total} = {G}_{ext} + {G}_{p o r e} + {G}_{excess} \qquad [ Formula 1 ]$$

Here, Gₑₓₜ is a gas storage amount in a region not filled with the porous material. Gₚₒᵣₑ is the storage amount of a normal density gas that has entered the pores of the porous material. G_{excess} is the amount of gas excessively adsorbed by the porous material.

Gₑₓₜ can be calculated by the following equation.

$${G}_{ext} = \frac{100 - F}{100} \times g \qquad [ Formula 2 ]$$

Here, F is a filling rate (%) of the porous material. g is the gas density (mol/L) at the same pressure. The contribution due to Gₑₓₜ decreases as the filling factor F of the porous material increases. For example, when F=100%, Gₑₓₜ=0 mol/L.

Gₚₒᵣₑ can be calculated by the following equation.

$${G}_{pore} = \frac{F}{100} \times ε \times g \qquad [ Formula 3 ]$$

Here, F is a filling rate (%) of the porous material. ε is the porosity of the porous material, and is a value determined by the product of the density ρ (g/cm³) of the porous material and the pore volume Vₚ (cm³/g) of the porous material.

G_{excess} can be calculated by the following equation.

$${G}_{e x c e s s} = \frac{F}{100} \times A \times ρ \times \frac{1}{22.7} \qquad [ Formula 4 ]$$

Here, F is a filling rate (%) of the porous material. A is the gas adsorption amount (cm³(STP)/g) of the porous material determined by the adsorption amount measurement. ρ is the density (g/cm³) of the porous material. In this formula, it is assumed that the gas is an ideal gas in STP with respect to the volume per mole (22.7 L/mol).

As can be seen from the above equation, in order to increase the gas storage quantity Gₜₒₜₐₗ, it is important to increase G_{excess}. And in order to increase G_{excess}, it is preferable to use a porous material having a large gas adsorption amount A while increasing the filling rate F of the porous material.

The filling rate F (%) of the porous material is not limited as long as the above conditions are satisfied. For example, F is 60% or more, preferably 65% or more, and more preferably 70% or more. In such a case, the effect of increasing the amount of gas stored by filling the porous material becomes more remarkable. The upper limit of the filling rate is 100%, but the filling rate may be slightly lowered from the viewpoint of gas filling efficiency, exhaust heat, and the like. For example, the filling rate of the porous material may be 99% or less. Further, the filling rate may be further reduced in consideration of an increase in the weight of the gas storage container due to the weight of the porous material itself.

As described above, the gas storage container according to this embodiment satisfies Δ_{1M}/δ_{1M}≥2 at 298 K for at least one kind of gas. Δ_{1M}/δ_{1M} is, for example, 4 or more, preferably 6 or more, more preferably 8 or more, and particularly preferably 10 or more.

The gas storage container according to this embodiment preferably satisfies Δ_{5M}/δ_{5M}≥1.5 at 298 K for at least one kind of gas. Δ_{5M}/δ_{5M} is, for example, 1.8 or more, preferably 2 or more, more preferably 4 or more, and particularly preferably 5 or more.

The gas storage container according to this embodiment preferably satisfies Δ_{10M}/δ_{10M}≥1.2 at 298 K for at least one kind of gas. Δ_{10M}/δ_{10M} is, for example, 1.5 or more, preferably 1.8 or more, more preferably 2 or more, and particularly preferably 3 or more.

The gas storage container according to this embodiment preferably satisfies Δ_{5M}/δ_{14.7M}≥0.3 at 298 K for at least one kind of gas. Δ_{5M}/δ_{14.7M} is, for example, 0.5 or more, preferably 0.6 or more, more preferably 0.8 or more, and particularly preferably 1 or more. When Δ_{5M}/δ_{14.7M} is 1 or more, the gas storage container can store an amount of gas at a low pressure of 5 MPa which is equal to or higher than the amount in an empty cylinder at 14.7 MPa

The gas storage container according to this embodiment preferably satisfies Δ_{1M}/δ_{14.7M}≥0.1 at 298 K for at least one kind of gas. Δ_{1M}/δ_{14.7M} is, for example, 0.2 or more, preferably 0.4 or more, more preferably 0.6 or more, still more preferably 0.8 or more, and particularly preferably 1 or more. When Δ_{1M}/δ_{14.7M} is 1 or more, the gas storage container can store an amount of gas at a low pressure of 1 MPa which is equal to or higher than the amount in an empty cylinder at 14.7 MPa.

As the porous material, for example, a metal organic framework (hereinafter also referred to as MOF), activated carbon, zeolite, mesoporous silica, or the like can be used. It is particularly preferable to use the MOF as the porous material. A plurality of types of porous materials may be used in combination.

When the MOF is employed as the porous material, any types of MOFs can be used. Appropriately combining the type and coordination number of the metal ion with the type and topology of the multidentate ligand leads to a MOF with a desired structure.

The metal elements in the MOF can be, for example, any elements belonging to alkali metals (Group 1), alkaline earth metals (Group 2), or transition metals (Groups 3 to 12). The multidentate ligand in the MOF typically is an organic ligand, examples of which include carboxylate anion and heterocyclic compound. Examples of the carboxylic acid anion include dicarboxylic acid anion and tricarboxylic acid anion. Specific examples include anions of citric acid, malic acid, terephthalic acid, isophthalic acid, trimesic acid, and derivatives thereof. Examples of the heterocyclic compound include bipyridine, imidazole, adenine, and derivatives thereof. Alternatively, the ligand may be an amine compound, a sulfonate anion, or a phosphate anion. The MOF may further contain monodentate ligand(s).

The combination of the metal and the ligand forming the MOF can be appropriately determined according to the expected function and the desired pore size. The MOF may contain two or more types of metal elements, and may contain two or more types of ligands. The MOF can be surface-modified with a polymer or other modifiers.

As specific examples of the metal organic structure, for example, those listed in Table 1 of the literature (Yabing He et al. Methane Storage in Metal-Organic Frameworks, Chem Soc Rev, 2014) can be used. Alternatively, those listed in other documents (Chem. Sci., 2014, 5, 32-51) may also be used. Those shown in Tables 1 to 3 below may also be used as the MOF. These are non-limiting lists, and other MOFs can also be used.

TABLE 1

| Name/Abbreviation | Metal (Cation) | Ligand (Anion) |
|---|---|---|
| CPL-1 | Cu | pzdc (2,3-pyrazinedicarboxylic acid), |
| | | pyz (pyrazine) |
| Cu₃(btc)₂ | Cu | BTC (trimesic acid) |
| Zn₂(14bdc)₂(dabco) | Zn | BDC (terephthalic acid), dabco (1,4- |
| | | diazabicyclo[2,2,2]octane) |
| ZIF-8 | Zn | imidazole |
| HKUST-1 | Cu | 1,3,5-benzenetricarboxylic acid |
| Mg₃(C₁₂O₁₄H₁₀) | Mg | citric acid |
| Ca₂(C₈O₁₂H₆) | Ca | malic acid |
| Ca₃(C₁₂O₁₄H₁₀) | Ca | citric acid |
| Ca(C₄O₆H₄) | Ca | malic acid |
| Cu(IPA) | Cu | isophthalic acid |
| MgBDC-1 | Mg | BDC (terephthalic acid) |
| MgDHBDC-1 | Mg | DHBDC (2,5-dihydroxyterephthalic acid) |
| MgOBA-1 | Mg | OBA (4,4′-oxobisbenzoic acid) |
| MgBTC-1 | Mg | BTC (trimesic acid) |
| MgBTB-1 | Mg | BTB (1,3,5-tri(4′-carboxy-4,4′- |
| | | biphenyl)benzene) |
| MgBTB-2 | Mg | BTB (1,3,5-tri(4′-carboxy-4,4′- |
| | | biphenyl)benzene) |
| MgBTB-3 | Mg | BTB (1,3,5-tri(4′-carboxy-4,4′- |
| | | biphenyl)benzene) |
| MgBTB-4 | Mg | BTB (1,3,5-tri(4′-carboxy-4,4′- |
| | | biphenyl)benzene) |
| MgBBC-1 | Mg | BBC (4,4′-4″-benzene-1,3,5-triyl- |
| | | tri-biphenylcarboxylic acid) |
| MIL-100(Fe) | Fe | BTC (trimesic acid) |
| MIL-101 | Fe | BDC (terephthalic acid) |
| MIL-53 | Fe | BDC (terephthalic acid) |
| BioMIL-5 | Zn | azelaic acid |
| CaZol nMOF | Ca | zoledronic acid |
| IRMOF-2 | Zn | o-Br-BDC (o-bromoterephthalic acid) |
| IRMOF-3 | Zn | H₂N-BDC (2-aminoterephthalic acid) |
| IRMOF-4 | Zn | [C₃H₇O]₂-BDC |
| IRMOF-5 | Zn | [C₅H₁₁O]₂-BDC |
| IRMOF-6 | Zn | [C₂H₄]-BDC |
| IRMOF-7 | Zn | 1,4-NDC (1,4-naphthalenedicarboxylic acid) |
| IRMOF-8 | Zn | 2,6-NDC (2,6-naphthalenedicarboxylic acid) |
| IRMOF-9 | Zn | BPDC (4,4′-biphenyldicarboxylic acid) |
| IRMOF-10 | Zn | BPDC (4,4′-biphenyldicarboxylic acid) |
| IRMOF-11 | Zn | HPDC (tetrahydropyrene-2,7-dicarboxylic acid) |
| IRMOF-12 | Zn | HPDC (tetrahydropyrene-2,7-dicarboxylic acid) |
| IRMOF-13 | Zn | PDC (pyrene dicarboxylic acid) |
| IRMOF-14 | Zn | PDC (pyrene dicarboxylic acid) |
| IRMOF-15 | Zn | TPDC (terphenyl dicarboxylic acid) |
| IRMOF-16 | Zn | TPDC (terphenyl dicarboxylic acid) |

TABLE 2

| Name/Abbreviation | Metal (Cation) | Ligand (Anion) |
|---|---|---|
| Zn₃(BTC)₂ | Zn | BTC (trimesic acid) |
| Zn₄O(NDC) | Zn | 1,4-NDC (1,4-naphthalenedicarboxylic acid) |
| Mg(Formate) | Mg | formic acid |
| Fe(Formate) | Fe | formic acid |
| Mg(C₆H₄O₆) | Mg | DHBDC (2,5-dihydroxyterephthalic acid) |
| ZnC₂H₄BDC | Zn | [C₂H₄]-BDC |
| MOF-49 | Zn | m-BDC |
| BPR95A2 | Zn | BDC (terephthalic acid) |
| BPR76D5 | Zn | BzPDC |
| BPR68D10 | Zn | BTC (trimesic acid) |
| BPR56E1 | Zn | BDC (terephthalic acid) |
| BPR49B1 | Zn | BDC (terephthalic acid) |
| BPR43G2 | Zn | BDC (terephthalic acid) |
| NO336 | Fe | formic acid |
| NO335 | Fe | formic acid |
| NO333 | Fe | formic acid |
| PCN-14 | Nb | 5,5′-(9,10-anthracenediyl) diisophosphate |
| Zn₄BNDC | Zn | BNDC (1,1′-binaphthyl-4,4′-dicarboxylic acid) |
| Zn₃(BPDC) | Zn | BPDC (4,4′-biphenyldicarboxylic acid) |
| ZnDBP | Zn | DBP (dibenzyl phosphate) |
| Zn₃(PDC)_{2.5} | Zn | PDC (pyrene dicarboxylic acid) |
| Zn(HPDC) | Zn | HPDC (tetrahydropyrene-2,7-dicarboxylic acid) |
| Zn(NDC) | Zn | 2,6-NDC (2,6-naphthalenedicarboxylic acid) |
| MOF-37 | Zn | 2,6-NDC (2,6-naphthalenedicarboxylic acid) |
| MOF-20 | Zn | 2,6-NDC (2,6-naphthalenedicarboxylic acid) |
| MOF-12 | Zn | ATC (1,3,5,7-adamantanetetracarboxylic acid) |
| Zn(ADC) | Zn | ADC (acetylenedicarboxylic acid) |
| MOF-0 | Zn | BTC (trimesic acid) |
| MOF-2 | Zn | BDC (terephthalic acid) |
| MOF-3 | Zn | BDC (terephthalic acid) |
| MOF-4 | Zn | BTC (trimesic acid) |
| MOF-5 | Zn | BDC (terephthalic acid) |
| MOF-38 | Zn | BTC (trimesic acid) |
| MOF-31 | Zn | ADC (acetylenedicarboxylic acid) |
| MOF-69A | Zn | BPDC (4,4′-biphenyldicarboxylic acid) |
| MOF-69B | Zn | 2,6-NDC (2,6-naphthalenedicarboxylic acid) |
| MOF-33 | Zn | ATB (adamantanetetrabenzoic acid) |
| MOF-36 | Zn | MTB (methanetetrabenzoic acid) |
| MOF-39 | Zn | BTB (1,3,5-tri(4′-carboxy-4,4′- |
| | | biphenyl)benzene) |

TABLE 3

| Name/Abbreviation | Metal (Cation) | Ligand (Anion) |
|---|---|---|
| NO305 | Fe | formic acid |
| NO306A | Fe | formic acid |
| BPR48A2 | Zn | BDC (terephthalic acid) |
| Zn(C₂O₄) | Zn | oxalic acid |
| MOF-48 | Zn | 2,6-NDC (2,6-naphthalenedicarboxylic acid) |
| MOF-47 | Zn | BDC(CH₃)₄ |
| Zn₃(BTC)₂ | Zn | BTC (trimesic acid) |
| MOF-n | Zn | BTC (trimesic acid) |
| Zehex | Zn | BTB (1,3,5-tri(4′-carboxy-4,4′- |
| | | biphenyl)benzene) |
| AS16 | Fe | BDC (terephthalic acid) |
| AS27-3 | Fe | BDC (terephthalic acid) |
| AS54-3 | Fe | BPDC (4,4′-biphenyldicarboxylic acid) |
| AS61-4 | Fe | m-BDC |
| AS68-7 | Fe | m-BDC |
| Zn₈(ad)₄(PDAC)₆(OH)₂ | Zn | adenine, PDAC (1,4-diphenyl diacrylic acid) |
| Zn₈(ad)₄(SBDC)₆(OH)₂ | Zn | adenine, SBDC (4,4′-stilbene dicarboxylic acid) |
| Zn₈(ad)₄(BPDC)₆(OH)₂ | Zn | adenine, BPDC |
| Zn₈(ad)₄(NDC)₆(OH)₂ | Zn | adenine, 2,6-NDC |
| M-CPO-27 | Mg | DHBDC (2,5-dihydroxyterephthalic acid) |
| bio-MOF-1 | Zn | adenine, BPDC |
| UMCM-1 | Zn | BTB (1,3,5-tri(4′-carboxy-4,4′- |
| | | biphenyl)benzene) |
| UMCM-2 | Zn | BTB (1,3,5-tri(4′-carboxy-4,4′- |
| | | biphenyl)benzene) |
| MOF-210 | Zn | BTE (4,4′,4″-[benzene-1,3,5-triyl-tris |
| | | (ethyne-2,1-diyl)] tribenzoic acid), BPDC |
| bio-MOF-100 | Zn | adenine, BPDC |
| NU-110E | Cu | J. Am. Chem. Soc. 2012, 134, 15016-15021 |
| CD-MOF-1 | K | γ-CD (γ-cyclodextrin) |
| porph@MOM-4 | Fe | porphyrin, BTC |
| porph@MOM-8 | Mg | porphyrin, BTC |
| porph@MOM-9 | Zn | porphyrin, BTC |
| ZnPO-MOF | Zn | metalloporphyrin pyridyl, TCPB (1,2,4,5- |
| | | Tetrakis(4-carboxyphenyl)benzene) |
| Uio-66 | Fe | DCBDT (1,4-dicarboxylbenzene-2,3-dithiolate) |
| Mg(H₂gal) | Mg | caustic acid (3,4,5-trihydroxybenzoic acid) |

There is no restriction in the form of the porous material. As the porous material, for example, a powdery material, a pellet material, a bead material, a film material, or a block material may be used. A plurality of forms of porous materials may be used in combination.

There is no restriction in the kind of gas stored in the gas storage container. Examples of such gases include nitrogen; oxygen; air; carbon dioxide; rare gases such as helium, neon, argon, krypton, and xenon; hydrogen; saturated hydrocarbons such as methane, ethane, and propane; acetylene; fluorocarbons such as difluoromethane; LP gas; natural gas; monosilane; theos; dichlorosilane; arsine; phosphine; diborane; boron trichloride; carbon tetrafluoride; nitrogen trifluoride; hydrogen bromide; chlorine; tungsten hexafluoride; hydrogen selenide; monogermane; ethylene oxide; nitrous oxide; and ammonia. Among these, it is particularly preferable to use a gas selected from the group consisting of nitrogen, oxygen, air, carbon dioxide, methane, hydrogen, natural gas, helium, neon, argon, krypton, and xenon.

### EXAMPLES

### Occupied Volume

As described above, according to the present invention, a gas storage container that can

be easily transported and installed is provided. Hereinafter, taking the gas storage container described with reference to FIGS. 1 to 3 as an example, it will be shown that the efficiency of the occupied volume can also be improved.

Conventional gas cylinders have the shape of bottles. Typically, its diameter is 23.2 cm, its height is 151 cm, and its volume is 47L. In addition to this, components for fixing the gas cylinder is required. Hereinafter, it is assumed that the fixing component has a bottom shape of 25 cm×25 cm square.

On the other hand, let us assume that a gas storage container described with reference to FIGS. 1 to 3 is a cubic container having the same side length of 25 cm. In this case, the volume per gas storage container is 25 cm×25 cm×25 cm =about 15.6 L. As mentioned above, this gas storage container can be stacked vertically. Assuming the same height as the conventional gas cylinder, six gas storage containers can be stacked. In this case, the total volume is about 15.6L×6=about 94L. That is, the capacity can be approximately doubled for almost the same occupied volume. In other words, if three gas storage containers are stacked, a capacity equivalent to that of one conventional gas cylinder can be achieved. Which also means, in this case, the occupied volume can be reduced to about half.

Further, as described above, the amount of stored gas can be further improved by introducing a porous material into the gas storage container. Hereinafter, the effect of the porous material will be additionally described.

### Preparation of Porous Material

The porous materials used herein are summarized in Table 4 below. In the table, HKUST-1 was synthesized using a twin-screw extruder according to the literature (Chem. Sci., 2015, 6, 1645-1649). ZIF-8, MIL-53 (Al), AX-21, and 13X are commercially available. The density and pore volume in the table were extracted from the literature (Chem. Sci., 2014, 5, 32-51).

TABLE 4

| Porous | | Density | Pore Volume | Porocity |
|---|---|---|---|---|
| Material | Category | ρ (g/cm³) | Vp (cm³/g) | ε |
| HKUST-1 | MOF | 0.881 | 0.770 | 0.678 |
| ZIF-8 | MOF | 1.14 | 0.49 | 0.559 |
| MIL-53 (Al) | MOF | 0.978 | 0.54 | 0.528 |
| AX-21 | Activated Carbon | 0.487 | 1.640 | 0.799 |
| X13 | Zeolite | 1.48 | 0.200 | 0.296 |

### Measurement of Adsorption Amount

The amount of adsorption was measured using BELSORP-HP (Microtrack Bell Co., Ltd.) at 298K. The porous materials in powder form were used for the measurements.

### Nitrogen

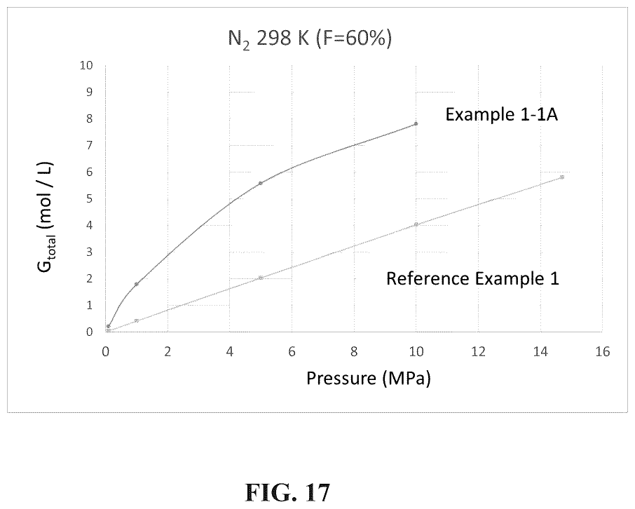

A comparison was made for the cases where the filling factor F was 60% and nitrogen was used as the gas. The results are summarized in Table 5 below and FIG. 17.

TABLE 5

| | Porous | | Filling | Pressure | Gₑₓₜ | Gₚₒᵣₑ | G_{excess} | Gₜₒₜₐₗ |
|---|---|---|---|---|---|---|---|---|
| Example | Material | | Rate | (MPa) | (mol/L) | (mol/L) | (mol/L) | (mol/L) |
| Example 1-1A | HKUST-1 | | 60% | 10 | 1.61 | 1.64 | 4.55 | 7.79 |
| | | | | 5 | 0.81 | 0.83 | 3.93 | 5.57 |
| | | | | 1 | 0.17 | 0.17 | 1.44 | 1.78 |
| | | | | 0.1 | 0.02 | 0.02 | 0.17 | 0.20 |
| Reference | None | | — | 14.7 | — | — | — | 5.80 |
| Example 1 | (Empty) | | | 10 | — | — | — | 4.02 |
| | | | | 5 | — | — | — | 2.03 |
| | | | | 1 | — | — | — | 0.42 |
| | | | | 0.1 | — | — | — | 0.04 |
| | Δ_{1M} | | Δ_{5M} | | Δ_{10M} | | | |
| Example | (mol/L) | Δ_{1M}/δ_{1M} | (mol/L) | Δ_{5M}/δ_{5M} | (mol/L) | Δ_{10M}/δ_{10M} | Δ_{5M}/δ_{14.7M} | Δ_{1M}/δ_{14.7M} |
| Example 1-1A | 1.57 | 4.21 | 5.37 | 2.70 | 7.59 | 1.91 | 0.93 | 0.27 |
| Reference | 0.37 | 1 | 1.98 | 1.00 | 3.98 | 1.00 | — | — |
| Example 1 | | | | | | | | |

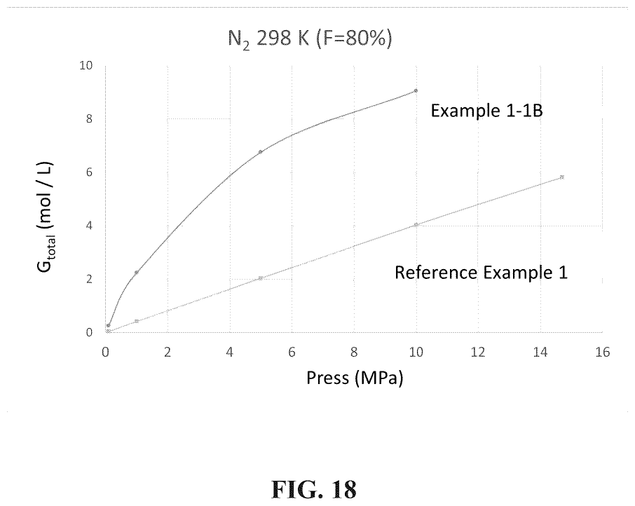

A comparison was made for the cases where the filling factor F was 80% and nitrogen was used as the gas. The results are summarized in Table 6 below and FIG. 18.

TABLE 6

| | Porous | | Filling | Pressure | Gₑₓₜ | Gₚₒᵣₑ | G_{excess} | Gₜₒₜₐₗ |
|---|---|---|---|---|---|---|---|---|
| Example | Material | | Rate | (MPa) | (mol/L) | (mol/L) | (mol/L) | (mol/L) |
| Example 1-1B | HKUST-1 | | 80% | 10 | 0.80 | 2.18 | 6.06 | 9.05 |
| | | | | 5 | 0.41 | 1.10 | 5.24 | 6.75 |
| | | | | 1 | 0.08 | 0.23 | 1.92 | 2.23 |
| | | | | 0.1 | 0.01 | 0.02 | 0.22 | 0.25 |
| Reference | None | | — | 14.7 | — | — | — | 5.80 |
| Example 1 | (Empty) | | | 10 | — | — | — | 4.02 |
| | | | | 5 | — | — | — | 2.03 |
| | | | | 1 | — | — | — | 0.42 |
| | | | | 0.1 | — | — | — | 0.04 |
| | Δ_{1M} | | Δ_{5M} | | Δ_{10M} | | | |
| Example | (mol/L) | Δ_{1M}/δ_{1M} | (mol/L) | Δ_{5M}/δ_{5M} | (mol/L) | Δ_{10M}/δ_{10M} | Δ_{5M}/δ_{14.7M} | Δ_{1M}/δ_{14.7M} |
| Example 1-1B | 1.97 | 5.28 | 6.49 | 3.27 | 8.79 | 2.21 | 1.13 | 0.34 |
| Reference | 0.37 | 1 | 1.98 | 1.00 | 3.98 | 1.00 | — | — |
| Example 1 | | | | | | | | |

### Oxygen

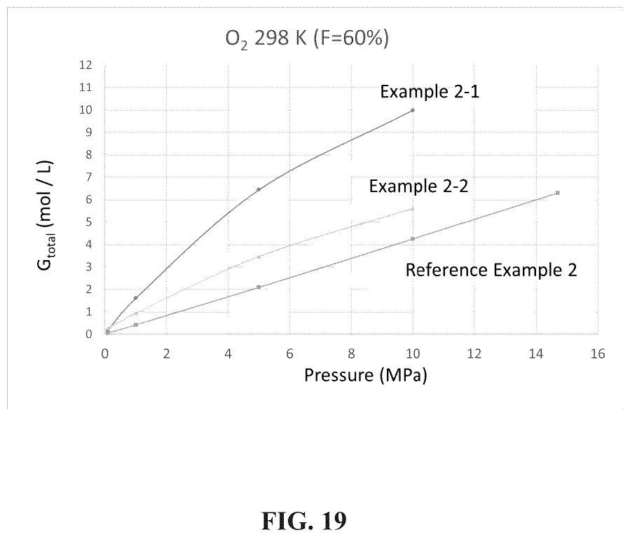

A comparison was made for the cases where the filling factor F was 60% and oxygen was used as the gas. The results are summarized in Table 7 below and FIG. 19.

TABLE 7

| | Porous | | Filling | Pressure | Gₑₓₜ | Gₚₒᵣₑ | G_{excess} | Gₜₒₜₐₗ |
|---|---|---|---|---|---|---|---|---|
| Example | Material | | Rate | (MPa) | (mol/L) | (mol/L) | (mol/L) | (mol/L) |
| Example 2-1 | HKUST-1 | | 60% | 10 | 1.70 | 1.73 | 6.55 | 9.98 |
| | | | | 5 | 0.83 | 0.85 | 4.76 | 6.44 |
| | | | | 1 | 0.16 | 0.17 | 1.27 | 1.60 |
| | | | | 0.1 | 0.02 | 0.02 | 0.15 | 0.18 |
| Example 2-2 | AX-21 | | 60% | 10 | 1.70 | 2.03 | 1.87 | 5.60 |
| | | | | 5 | 0.83 | 1.00 | 1.64 | 3.47 |
| | | | | 1 | 0.16 | 0.20 | 0.58 | 0.94 |
| | | | | 0.1 | 0.02 | 0.02 | 0.23 | 0.27 |
| Reference | None | | — | 14.7 | — | — | — | 6.29 |
| Example 2 | (Empty) | | | 10 | — | — | — | 4.24 |
| | | | | 5 | — | — | — | 2.08 |
| | | | | 1 | — | — | — | 0.41 |
| | | | | 0.1 | — | — | — | 0.04 |
| | Δ_{1M} | | Δ_{5M} | | Δ_{10M} | | | |
| Example | (mol/L) | Δ_{1M}/δ_{1M} | (mol/L) | Δ_{5M}/δ_{5M} | (mol/L) | Δ_{10M}/δ_{10M} | Δ_{5M}/δ_{14.7M} | Δ_{1M}/δ_{14.7M} |
| Example 2-1 | 1.42 | 3.87 | 6.25 | 1.96 | 9.80 | 2.33 | 1.00 | 0.23 |
| Example 2-2 | 0.67 | 1.84 | 3.19 | 1.57 | 5.33 | 1.27 | 0.51 | 0.11 |
| Reference | 0.37 | 1 | 2.04 | 1.00 | 4.20 | 1.00 | — | — |
| Example 2 | | | | | | | | |

### Methane

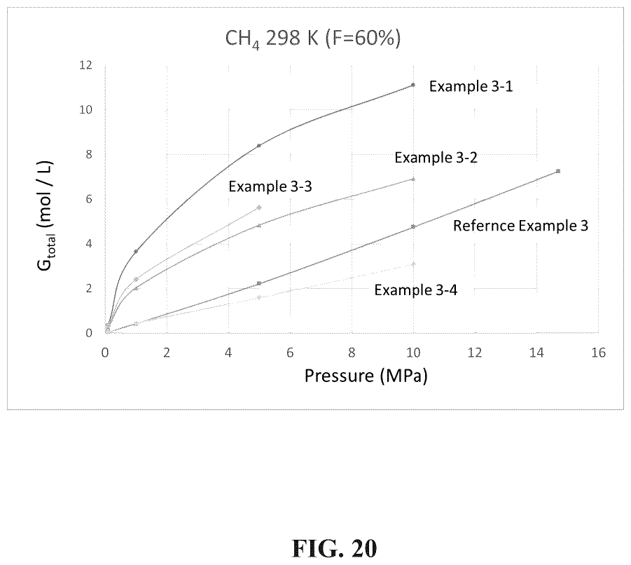

A comparison was made for the cases where the filling rate was F=60% and methane was used as the gas. The results are summarized in Table 8 below and FIG. 20.

TABLE 8

| | Porous | | Filling | Pressure | Gₑₓₜ | Gₚₒᵣₑ | G_{excess} | Gₜₒₜₐₗ |
|---|---|---|---|---|---|---|---|---|
| Example | Material | | Rate | (MPa) | (mol/L) | (mol/L) | (mol/L) | (mol/L) |
| Example 3-1 | HKUST-1 | | 60% | 10 | 1.90 | 1.93 | 7.27 | 11.10 |
| | | | | 5 | 0.88 | 0.90 | 6.61 | 8.39 |
| | | | | 1 | 0.17 | 0.17 | 3.30 | 3.64 |
| | | | | 0.1 | 0.02 | 0.02 | 0.33 | 0.37 |
| Example 3-2 | ZIF-8 | | 60% | 10 | 1.90 | 1.59 | 3.42 | 6.91 |
| | | | | 5 | 0.88 | 0.74 | 3.21 | 4.83 |
| | | | | 1 | 0.17 | 0.14 | 1.71 | 2.01 |
| | | | | 0.1 | 0.02 | 0.01 | 0.21 | 0.25 |
| Example 3-3 | MIL-53 | | 60% | 10 | — | — | — | — |
| | (Al) | | | 5 | 0.88 | 0.70 | 4.05 | 5.63 |
| | | | | 1 | 0.17 | 0.13 | 2.11 | 2.41 |
| | | | | 0.1 | 0.02 | 0.01 | 0.29 | 0.33 |
| Example 3-4 | 13X | | 60% | 10 | 1.90 | 0.84 | 0.37 | 3.10 |
| | | | | 5 | 0.88 | 0.39 | 0.33 | 1.60 |
| | | | | 1 | 0.17 | 0.07 | 0.21 | 0.44 |
| | | | | 0.1 | 0.02 | 0.01 | 0.03 | 0.05 |
| Reference | None | | — | 14.7 | — | — | — | 7.24 |
| Example 3 | (Empty) | | | 10 | — | — | — | 4.74 |
| | | | | 5 | — | — | — | 2.20 |
| | | | | 1 | — | — | — | 0.41 |
| | | | | 0.1 | — | — | — | 0.04 |
| | Δ_{1M} | | Δ_{5M} | | Δ_{10M} | | | |
| Example | (mol/L) | Δ_{1M}/δ_{1M} | (mol/L) | Δ_{5M}/δ_{5M} | (mol/L) | Δ_{10M}/δ_{10M} | Δ_{5M}/δ_{14.7M} | Δ_{1M}/δ_{14.7M} |
| Example 3-1 | 3.27 | 8.84 | 8.02 | 3.71 | 10.73 | 2.28 | 1.11 | 0.45 |
| Example 3-2 | 1.77 | 4.78 | 4.58 | 2.12 | 6.66 | 1.42 | 0.64 | 0.25 |
| Example 3-3 | 2.08 | 5.63 | 5.30 | 2.46 | — | — | 0.34 | 0.29 |
| Example 3-4 | 0.39 | 1.05 | 1.55 | 0.72 | 3.05 | 0.65 | 0.21 | 0.05 |
| Reference | 0.37 | 1 | 2.16 | 1.00 | 4.70 | 1.00 | — | — |
| Example 3 | | | | | | | | |

1. A portable gas storage container having flat upper surface and a flat lower surface, and being vertically stackable; wherein the portable gas storage container comprises:
a casing with a flat upper surface and a flat lower surface and being vertically stackable;
a gas container installed in the casing; and
a gas remaining amount measurement module installed in a space between the casing and the gas container, the gas remaining amount measurement module comprising a pressure sensor connected to the gas container, a central processing unit connected to the gas pressure sensor, and a wireless communication module connected to the central processing unit;
wherein the portable gas storage container is approximately cubic in shape; and
wherein the gas remaining amount measurement module is installed in the space between the casing and the gas container so as not to be visible from outside.

2. The portable gas storage container according to claim 1, wherein a gas outlet is provided on at least one side surface thereof.

3. The portable gas storage container according to claim 2, wherein the at least one side surface has a recess, and the gas outlet is provided in the recess.

4. The portable gas storage container according to claim 1, further comprising a grip.

5. The portable gas storage container according to claim 1, wherein the gas remaining amount measurement module further comprises a temperature sensor connected to the central processing unit.

6. The portable gas storage container according to claim 1, wherein the gas remaining amount measurement module further comprises a GPS module connected to the central processing unit.

7. The portable gas storage container according to claim 1, further comprising a porous material in the gas container.

8. The portable gas storage container according to claim 7, wherein the porous material is a Metal Organic Framework.

9. The portable gas storage container according to claim 3, wherein the gas outlet is entirely contained within the recess such that the gas outlet does not protrude beyond the periphery of an outer surface of the casing of the portable gas storage container.

10. The portable gas storage container according to claim 4, wherein the grip is an integrally- formed grip that spans a length of the casing of the portable gas storage container.

11. The portable gas storage container according to claim 1, wherein the gas container is approximately spherical in shape.

12. The portable gas storage container according to claim 1, wherein a single gas container is installed in the casing.

13. The portable gas storage container according to claim 1, wherein a material used for the casing and a material used for the gas container are different from each other.

14. The portable gas storage container according to claim 1, wherein the casing has rounded edges and corners.

15. The portable gas storage container of claim 7, wherein the porous material consisting essentially of a porous gas-adsorption material positioned within the gas container, wherein a type of the porous material and a filling rate F of the porous material in the gas container is selected such that a pressure and a content of a gas satisfies Δ_{1M}/δ_{1M}≥1.5 at 298 K for at least one kind of gas, in which Δ_{1M}=G_{1M}−G_{0.1M} and δ_{1M}=g_{1M}−g_{0.1M}, and G_{1M} is a content of the gas at 1 MPa when the porous material is contained in the gas container, G_{0.1M} is a content of the gas at 0.1 MPa when the porous material is contained in the gas container, g_{1M} is a content of the gas at 1 MPa when the porous material is not contained in the gas container, and g_{0.1M} is a content of the gas at 0.1 MPa when the porous material is not contained in the gas container.

16. The portable gas storage container according to claim 15, wherein the filling rate F of the porous material in the gas container is 60% or more and 99% or less.

17. The portable gas storage container according to claim 15, wherein the gas is selected from the group consisting of nitrogen, oxygen, air, carbon dioxide, methane, hydrogen, natural gas, helium, neon, argon, krypton, and xenon.

18. The portable gas storage container according to claim 3, further comprising a grip, wherein the grip is an integrally-formed grip that spans a length of the casing of the portable gas storage container.

19. The portable gas storage container according to claim 18, wherein the gas outlet is entirely contained within the recess such that the gas outlet does not protrude beyond the periphery of an outer surface of the casing of the portable gas storage container.

20. The portable gas container according to claim 18, wherein the gas remaining amount measurement module further comprises a temperature sensor connected to the central processing unit.
